(19) United States
(12) Patent Application Publication
(10) Pub. No.: US 2025/0220603 A1
(43) Pub. Date: Jul. 3, 2025

(54) SYNCHRONIZATION OF MULTI-MODAL FLOWS

(71) Applicant: InterDigital Patent Holdings, Inc., Wilmington, DE (US)

(72) Inventors: Michael Starsinic, Newtown, PA (US); Magurawalage Chathura Madhusanka Sarathchandra, London (GB); Xavier De Foy, Kirkland (CA); Achref Methenni, Montreal (CA); Rocco Di Girolamo, Laval (CA); Saad Ahmad, Montreal (CA); Michelle Perras, Montreal (CA); Samir Ferdi, Kirkland (CA); Loic Fontaine, Noyal Sur Vilaine (FR); Patrice Hirtzlin, Betton (FR)

(73) Assignee: InterDigital Patent Holdings, Inc., Wilmington, DE (US)

(21) Appl. No.: 18/850,039

(22) PCT Filed: Mar. 23, 2023
(86) PCT No.: PCT/US2023/016037

§ 371 Date: Sep. 23, 2024

Related U.S. Application Data
(60) Provisional application No. 63/324,432, filed on Mar. 28, 2022.
(60) Provisional application No. 63/435,422, filed on Dec. 27, 2022.

(51) Int. Cl. H04W 56/00; H04L 41/5067; H04W 76/20

(52) U.S. Cl. CPC H04W 56/0015; H04L 41/5067; H04W 76/20

(57) ABSTRACT

A device for synchronizing multi-modal flows may receive synchronization information associated with a protocol data unit (PDU) session. The synchronization information may indicate a first flow classifier, a second flow classifier, and a synchronization threshold. A first data flow may be determined based on the first flow classifier. A second data flow may be determined based on the second flow classifier. The first data flow and the second data flow may be associated with the PDU session. A synchronization measurement may be determined based on the synchronization information. The synchronization measurement indicates a synchronization value indicative of synchronization between the first data flow and the second data flow. The device may determine that the first data flow and the second data flow are asynchronous based on the synchronization measurement.

### CROSS-REFERENCE TO RELATED APPLICATIONS

This application claims the benefit of U.S. Provisional Patent Application No. 63/324,432, filed Mar. 28, 2022, and U.S. Provisional Patent Application No. 63/435,422, filed Dec. 27, 2022, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein to synchronize multi-modal flows. A device (e.g., a wireless transmit/receive unit (WTRU)) may receive synchronization information associated with a protocol data unit (PDU) session. The synchronization information may indicate a first flow classifier, a second flow classifier, and a synchronization threshold. The device may determine a first data flow based on the first flow classifier and a second data flow based on the second flow classifier. The first data flow and the second data flow may be associated with the PDU session. The device may determine a synchronization measurement based on the synchronization information. The synchronization measurement may indicate a synchronization value indicative of synchronization between the first data flow and the second data flow. The device may determine that the first data flow and the second data flow are asynchronous based on the synchronization measurement being at or above the synchronization threshold. The device may send a message to a network node indicating that the first data flow and the second data flow are asynchronous.

The synchronization value may be based, at least in part, on a duration of time between a first time value associated with the first data flow and a second time value associated with the second data flow. The synchronization value may be based, at least in part, on a time difference. The device may determine a first time value associated with the arrival of data of the first data flow, and a second time value associated with the arrival of data of the second data flow and determine the time difference using the first time value and the second time value. The time difference may indicate a duration of time between the first time value and the second time value.

The message may indicate the time difference, wherein the time difference is used to synchronize the first data flow and the second data flow. The message may indicate a request for the first data flow and the second data flow to be synchronized based on the time difference. The message may indicate a request for the first data flow and the second data flow to be synchronized. The message may be a non-access stratum-session management (NAS-SM) message, and wherein the network node is a session management function (SMF).

The first flow classifier may include a packet filter. Determining the first data flow based on the first flow classifier may involve the device determining, based on the packet filter, that a plurality of PDU sets are associated with a data type. The first data flow may include the plurality of PDU sets. The first flow classifier may include a flow identifier. Determining the first data flow based on the first flow classifier may involve the device determining that a plurality of PDU sets include an indication of the flow identifier. The first data flow may include the plurality of PDU sets. The indication of the flow identifier may be included in a header of the plurality of PDU sets.

A WTRU and/or user plane function (UPF) may send synchronization status messages to network functions and/or application servers. A WTRU and/or UPF may add information in the headers of protocol data units (PDUs). For example, information may be added to the headers so that another WTRU and/or UPF may detect which PDU sets to synchronize (e.g., need to be synchronized). Network functions and/or application servers may use the information to improve the overall quality of experience of the WTRU and of other WTRUs that are part of the same multi-modal data set. For example, a WTRU, application function (AF), or UPF may provide synchronization functionality. Synchronization functionality may include calculating the degree to which flows are, or are not, synchronized and determining how much to delay one or more flows to make the degree at which the flows are synchronized within a synchronization threshold. Synchronization correction may be applied to correct jitter issues in flows. The network layer synchronization and jitter improvement procedure may be used to enhance application layer protocols that may be used to correct synchronization and jitter issues.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of protocol data unit (PDU) sets and PDU set flows.

FIG. 3 shows an example of PDU sets in synchronization groups.

FIG. 4 shows an example of a PDU header.

FIG. 5 shows an example of a non-access stratum (NAS)-based synchronization status notification.

FIG. 6 shows an example of an X5-based synchronization status notification.

FIG. 7 shows an example of synchronizing at the user plane function (UPF) via a session management function (SMF) provided delays.

FIG. 8 shows an example of synchronizing at the UPF via SMF provided delays.

### DETAILED DESCRIPTION

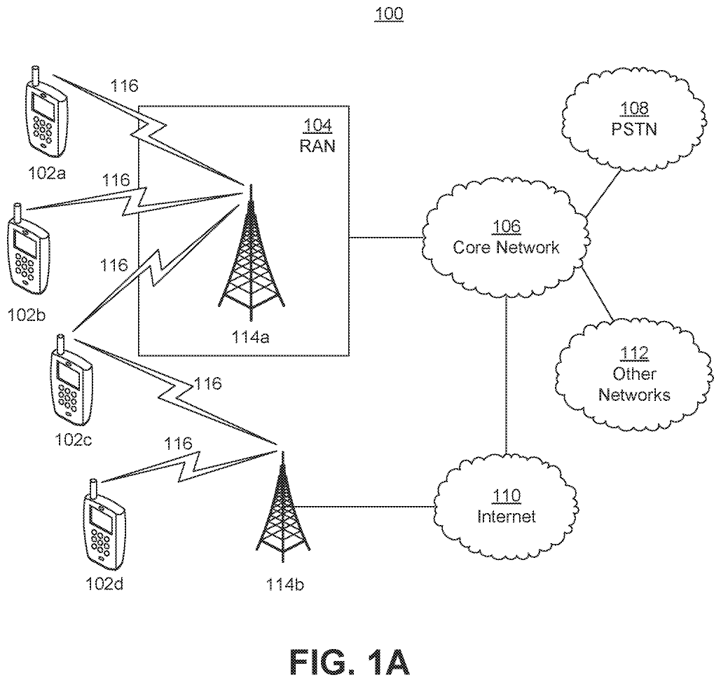

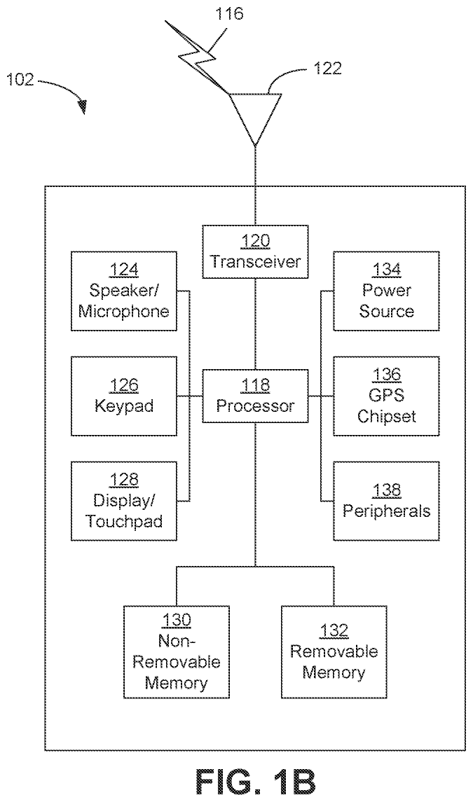

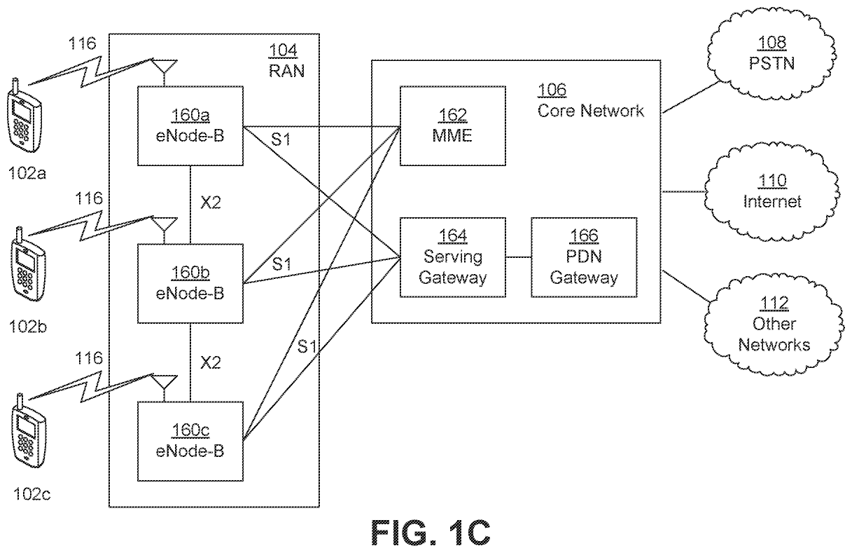

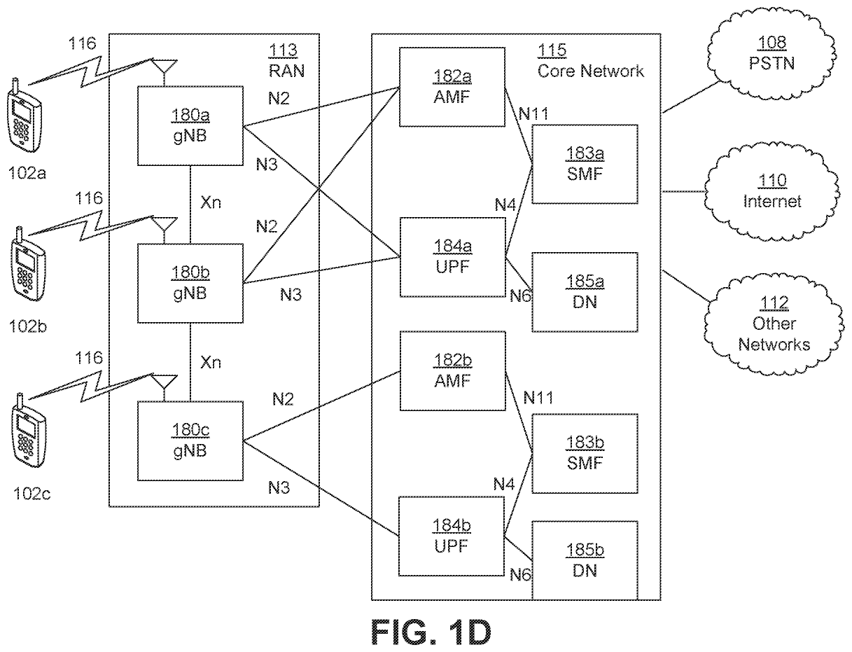

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 1020, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 1020, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 1020 may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 1020, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 1020, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 1020, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 1020, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 1600, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 1020, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes, Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 1800, though it will be appreciated that the RAN 113 may include any number of gNBs while remaining consistent with an embodiment. The gNBs 180a, 180b, 1800 may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 1800 may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 1800 may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

A protocol data unit (PDU) set may include one or more PDUs carrying the payload of a unit (e.g., one unit) of information generated at the application level (e.g., a frame and/or video slice for extended reality media (XRM) services), which may be used at the application layer. The application layer may use PDUs (e.g., all PDUs) in a PDU set (e.g., needed) to use the corresponding unit of information. In examples, the application layer may recover parts of the information unit if one or more PDUs are missing.

A multi-modal synchronization threshold may be defined as the maximum tolerable temporal separation of the onset of stimuli (e.g., two stimuli), one of which may be presented to one sense and the other to another sense such that the accompanying sensory object(s) may be perceived as being synchronous. A synchronization threshold may be described as the maximum tolerable temporal separation between the transmission or reception of flows (e.g., two flows). For example, if the temporal separation between the transmission or reception of flows is greater than the synchronization threshold, then the flows may be described as not synchronized, out-of-synchronization, or asynchronous. Similarly, if the temporal separation between the transmission or reception of flows is less than the synchronization threshold, the flows may be described as synchronized, in-synchronization, or synchronous.

As described with respect to a PDU set, the unit of information may be an application layer unit of information. The terms “unit of information” and “application layer unit of information” may be used interchangeably herein.

The terms “application server” and “application function” may be used interchangeably herein.

The following acronyms are used herein:

| | |
|---|---|
| AC | Application Client |
| AF | Application Function |
| AMF | Access and Mobility Function |
| AN | Access Network |
| API | Application Programing Interface |
| AS | Application Server |
| AT | Attention |
| BSF | Binding Support Function |
| DL | Downlink |
| DN | Data Network |
| DNN | Data Network Name |
| DNAI | Data Network Access Identifier |
| GFBR | Guaranteed Flow Bit Rate |
| GPSI | Generic Public Subscription Identifier |
| GUI | Graphical User Interface |
| ID | Identifier |
| IP | Internet Protocol |
| LADN | Local Area Data Network |
| LAN | Local Area Network |
| MT | Mobile Termination |
| NAS | Non-Access Stratum |
| NAS-MM | NAS - Mobility Management |
| NAS-SM | NAS - Session Management |
| NEF | Network Exposure Function |
| NSSAI | Network Slice Selection Assistance Information |
| NWDAF | Network Data Analytics Function |
| OAM | Operations Administration and Maintenance |
| PCC | Policy Charging and Control |
| PCF | Policy Control Function |
| PDU | Protocol Data Unit |
| PDR | Packet Detection Rule |
| PER | Packet Error Rate |
| ProSe | Proximity Services |
| PSA | PDU Session Anchor |
| PSI | PDU Session Inactive / Active Indication |
| QFI | QoS Flow Identifier |
| QoS | Quality of Service |
| QoE | Quality of Experience |
| RAN | Radio Access Network |
| RAT | Radio Access Technology |
| RSD | Route Selection Descriptor |
| SMF | Session Management Function |
| SSC | Session and Service Continuity |
| SSID | Service Set Identifier |
| S-NSSAI | Single NSSAI |
| TE | Terminal Equipment |
| UE | User Equipment |
| UL | Uplink |
| UPF | User Plane Function |
| URSP | UE Route Selection Policy |
| VN | Virtual Network |
| VR | Virtual Reality |
| XR | Extended Reality |

Multi-modal data may be provided. Multi-modal data may be input data from different devices and/or sensors or the output data to different destinations (e.g., one or more WTRUs) used (e.g., required) for the same task and/or application. Multi-modal data may comprise multiple single-modal data, and there may be a dependency among the single-modal data (e.g., each single-modal data). Single-modal data may be seen as one type of data.

A device and/or sensor that generates (e.g., sends) single-modal data may be a WTRU or may use a WTRU to send single-modal data to a network. Single-modal data may be sent to an application(s) hosted on other WTRUs and/or application(s) hosted on network servers.

A device and/or sensor that receives single-modal data may be a WTRU or may use a WTRU to receive single-modal data from a network. Single-modal data may be received from an application(s) hosted on other WTRUs and/or applications hosted on network servers.

As described herein, single-modal data may be a data flow to and/or from a WTRU and multi-modal data may comprise multiple data flows to and/or from multiple WTRUs.

A multi-modal data set may be a set of single-modal data flows used for a task and/or application (e.g., the same task and/or application). For example, a multi-modal data set may be a set of internet protocol (IP) flows and/or QoS flows between multiple WTRUs and an application server (e.g., a single application server). For example, the IP flows may carry sensor data, video information, haptic data, audio data, etc.

A QoS framework may be provided. A QoS model may be based on QoS flow(s). A QoS flow may be associated with QoS features (e.g., requirements) as specified by one or more QoS parameters and/or one or more QoS characteristics. The QoS Flow may be a granularity of QoS differentiation (e.g., the finest granularity of QoS differentiation) in the PDU session. A QoS Flow ID (QFI) may be used to identify a QoS flow in a system. User plane traffic with the QFI (e.g., the same QFI) within a PDU session may receive the same traffic forwarding treatment (e.g., scheduling and/or admission threshold). The QFI may be carried in an encapsulation header on N3 (e.g., and/or N9), for example, without changes (e.g., any changes) to the end-to-end (E2E) packet header.

A QoS flow may be controlled by the SMF and may be preconfigured and/or established via the PDU session establishment procedure or the PDU session modification procedure.

A QoS flow may be characterized by one or more of a QoS profile, a QoS rule, and an N4 Rule. The QoS Profile, QoS Rule, and N4 Rule may indicate a QoS flow priority level, a QoS class identifier (e.g., a QoS parameter), a UL PDR, and a DL PDR. The QoS flow may be controlled by the SMF. The QoS flow may be preconfigured. The QoS flow may be established via the PDU session establishment procedure, the PDU session modification procedure, and/or the like. A QoS flow may be characterized by a QoS profile. For example, the SMF may provide the QoS profile to the AN over the N2 reference point. For example, the QoS profile may be preconfigured in the AN. One or more of a QoS rule, a QoS flow priority level, and a QoS class identifier may be provided by the SMF to the WTRU, for example, via the AMF over the N1 reference point. The WTRU may derive one or more of a QoS rule, a QoS flow priority level, and a QoS class identifier, for example, by applying a reflective QoS control. The SMF may provide the UPF with N4 Rules that indicate an UL PDR and DL PDR that is associated with a QoS Flow.

In an embodiment, a QoS flow may be characterized by a QoS profile provided by the SMF to the access network (AN) via the AMF over the N2 reference point or preconfigured in the AN, by one or more QoS rule(s), by (e.g., optionally by) one or more QoS flow level QoS parameters associated with the QoS rule(s), any of which may be provided by the SMF to the WTRU via the AMF over the N1 reference point and/or derived by the WTRU by applying reflective QoS control and by one or more uplink (UL) and downlink (DL) packet detection rule(s) (PDR(s) provided by the SMF to the user plane function (UPF).

Supporting tactile and/or multimodality communication services may provide a number of multimodality use cases where an application uses (e.g., requires) the transmission of multiple single-modal data flows (e.g., audio, video, and/or haptic) to be played out to the user at the same time.

In examples, synchronization may be used (e.g., needed). For example, a user may use multiple independent devices (e.g., WTRUs) for consuming a multi-sensory application experience. In such a case, the multi-modal streams may be distributed among the devices (e.g., video stream played on a TV, audio stream played on a sound system, etc.). For example, multiple users may consume the same media (e.g., a group of users watching a football game together while conversing on it over a call), and the media may be presented to the users (e.g., all users) in the group (e.g., at the same time). For example, multiple players may participate in a gaming session with extended reality (XR) content that may be shared.

In examples described herein, multiple temporally dependent streams may be distributed among distributed WTRUs. A time difference (e.g., even a small time difference) between the streams may impact the user experience (e.g., audio played out later than the video). The time difference may cause one or more users to consume the media before others. The users behind (e.g., consume the media after other users) may need time to catch up with the other users.

An XR application (e.g., single XR application) may use (e.g., require) a set of single-modal data flows (e.g., audio, video, and/or haptic) to be transferred and played back to the user at the same time. In such a case, data of multi-modal flows may be delivered in a time window to be presented to the user (e.g., at the same time). Falling to do so may reduce the quality of experience (QoE) of the application. A multimodal application experience may include flows with varying modes and/or types of data (e.g., audio, video, and/or haptic), and the modes and/or types (e.g., each mode and/or type) of data may impose varying requirements (e.g., synchronization and/or latency) on the transmission.

For presenting multi-modal data to the user at the same time, the inter-related (e.g., temporal) data may be synchronously delivered to the distributed WTRUs. The synchronization threshold of multi-modal flows may specify the tolerable temporal separation between the onset of two stimuli (e.g., visual, audio and/or haptic). Failing to meet the synchronization threshold may result in the user perceiving multi-modal media as out of synchronization. Different modalities (e.g., flows) may have different data rates (e.g., packet rates) and/or decoding rates. For example, flows that carry video, audio, and/or haptic feedback may have different data rates and/or decoding rates. In examples, the network conditions under which a flow (e.g., each flow) is transferred may cause the arrival of flows at the destination(s) (e.g., WTRU(s)) at different times, leading to out-of-synchronization delivery (e.g., asynchronous delivery and/or asynchronized delivery), asynchronous playout (e.g., media, such as audio and video, may be played out in an asynchronous manner), and/or increased buffering. The buffering capabilities of the WTRU may constrain how well the WTRU may synchronize data flows.

In examples, where the arrival times of flows exceed a synchronization threshold (e.g., the flows are considered asynchronous), the system may be able to change how one or more of the flows are treated by the network to bring the flows within the synchronization threshold. The system may support a feature that allows the system to be notified that one or more flows have exceeded a synchronization threshold. For example, the system may be notified that one or more flows are asynchronous. In systems, the application layer may be able to detect that the flows are not synchronized and take application layer actions to synchronize the flows (e.g., reduce a frame rate and/or codec setting). If the system is able to take action to bring the flows within the synchronization threshold, the application layer may be able to avoid taking actions that may decrease the QoE (e.g., such as reducing a frame rate and/or using a less desirable codec setting). If notified of the synchronization issue (e.g., that the flows are asynchronous), the system may make adjustments (e.g., allocate more resources) so that actions at the application layer (e.g., frame rate reduction) do not need to be taken. Allowing the system to make adjustments to facilitate synchronization may result in more efficient use of network resources because the network may be configured to allocate enough resources (e.g., only enough resources) to provide the level of service that is used (e.g., required) by the application. The network may ensure that participants (e.g., all participants) in the extended reality and media (XRM) service receive data at the appropriate time and that no participant may gain an advantage by receiving data before other participants (e.g., in a gaming scenario). The system may be configured such that it is able to acquire synchronization-related information (e.g., from WTRUs and/or network functions) and use the information to determine how to allocate resources to flows and help improve the synchronization of flows (e.g., may address asynchronous flows), which may help the WTRU avoid buffer underflow and/or overflow conditions.

In cases where multi-modal flows are within a synchronization threshold (e.g., meeting a synchronization requirement and/or preventing flows from becoming asynchronous), the system may not support a feature that allows the system to be notified that flows are meeting the synchronization threshold. If the system is notified that flows are meeting the synchronization threshold (e.g., the flows are not asynchronous), the system may redistribute resources among the flows such that resources are distributed among the flows depending on their usage (e.g., free up resources that are not being used by some flows and allocate the resources to other flows that require more). The system may be configured to receive notifications regarding synchronized flows and redistribute resources among flows (e.g., based on the notifications).

A WTRU and/or UPF may send synchronization status messages to network functions and/or application servers. The synchronization status messages may indicate if one or more flows are synchronous or asynchronous.

A WTRU and/or UPF may add information in the headers of PDUs (e.g., so that other WTRUs or UPFs may detect which PDU sets are synchronized).

Network functions and/or application servers may use the information to improve the quality of experience of the WTRU and other WTRUs that are part of the same multi-modal data set. For example, a WTRU, AF, and/or UPF may provide synchronization functionality. Synchronization functionality may include calculating the degree to which flows are, or are not, synchronized. Synchronization functionality may include determining how much to delay one or more flows to increase the degree to which the flows are synchronized (e.g., to reduce the temporal separation between the flows, for example, to bring the degree to which the flows are synchronized within a synchronization threshold).

Concepts for synchronization correction may be applied to correct jitter issues in flows. The network layer synchronization and/or jitter improvement procedure described herein may be used to enhance application layer protocols that may be used to correct synchronization and/or jitter issues.

An XR (e.g., a 5GXR) application and an XR session handler may be examples of WTRU-hosted applications. The functionality described herein as residing in a WTRU-hosted application may reside in a layer between the PDU layer and the application layer or in the service data adaptation protocol (SDAP) layer.

PDUs and PDU sets may be associated. As described herein, a PDU set may comprise one or more PDUs. The one or more PDUs may carry the payload of a unit (e.g., one unit) of information generated at the application level (e.g., a frame or video slice for XRM services). The one or more PDUs may be and/or may have the same or similar priority (e.g., an importance requirement) at the application layer.

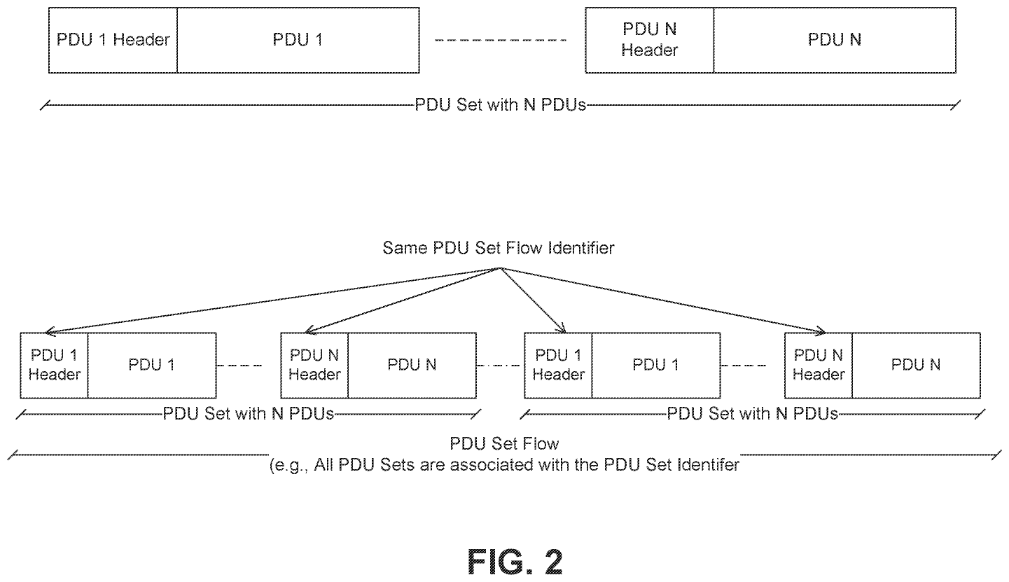

FIG. 2 illustrates an example of a PDU set with N PDUs. A PDU (e.g., each PDU) in the PDU set may be associated with a PDU header. FIG. 2 shows an example of PDU sets and PDU set flows. As shown in FIG. 2, PDU sets associated with the same type of unit of information may be called a PDU set flow.

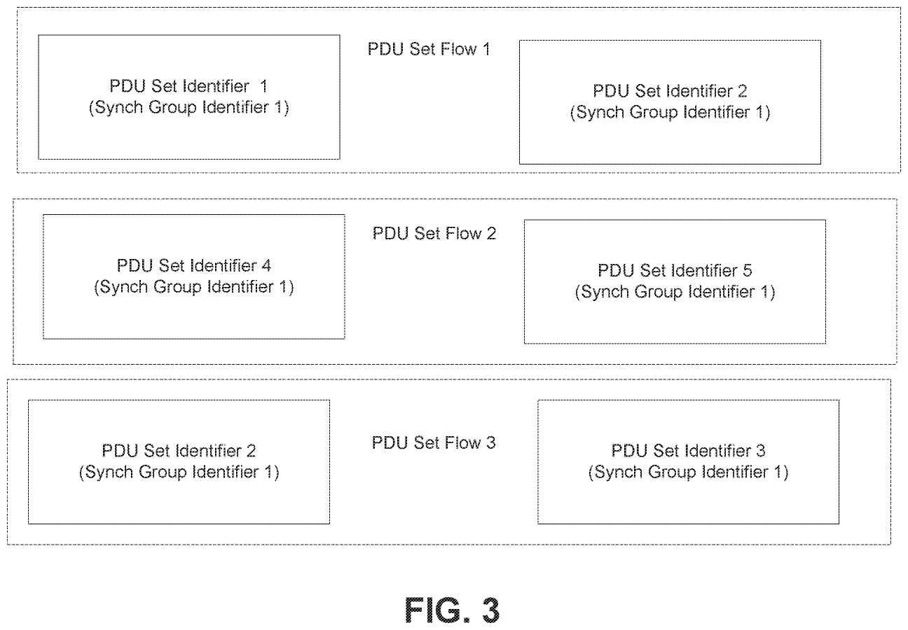

FIG. 3 illustrates an example of PDU sets in synchronization groups. As shown in FIG. 3, three PDU set flows may be (e.g., may need to be) synchronized and may be associated with the same synchronization group identifier. In examples, a PDU set flow (e.g., one PDU set flow) may carry audio data, a PDU set flow (e.g., one PDU set flow) may carry video data, and a PDU set flow (e.g., one PDU set flow) may carry haptic data (e.g., haptic feedback). The PDU set flows (e.g., all PDU set flows, for example, the three PDU set flows illustrated in FIG. 3) may be transmitted and received via the same or different PDU sessions. As illustrated in FIG. 3, the PDU sets may be identified by a PDU set identifier, and the PDU set identifier may be (e.g., may need to be) unique within a PDU set flow.

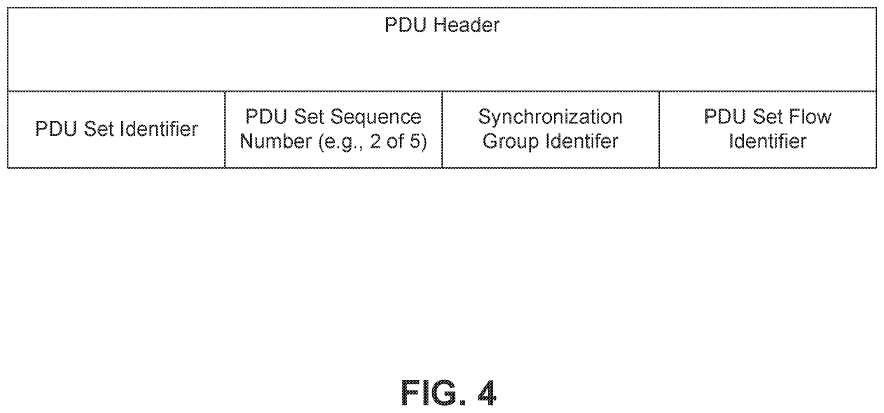

In some examples, a PDU header may be populated in the uplink. FIG. 4 illustrates an example of a PDU header.

The header may include a PDU set identifier, as illustrated in FIG. 4. The PDU set identifier may be a number that may be unique within the PDU session. The WTRU may populate the PDU header in the uplink with the PDU set identifier. The WTRU may use a PDU set association and treatment rule to determine what PDU set identifier should be associated with a unit of information. The PDU set identifier may be incremented when (e.g., each time) a PDU set is transmitted in the flow and may have a defined modulo count. For example, if three bits are allocated to express the PDU set identifier, the PDU sets may be numbered 0, 1, 2, 3, 4, 5, 6, 7, 0, 1, etc. Assigning the PDU set identifiers in this fashion may help the WTRU and UPF detect dropped packet(s).

The PDU set association and treatment rule may be received by the WTRU in a NAS-SM message (e.g., a PDU session establishment accept the message or a PDU session modification command) from the SMF that serves the PDU session that is associated with the application that generated the unit of information. The PDU set association and treatment rule may include a packet filter and/or a PDU set flow identifier (e.g., a flow classifier), For example, a first data flow may be determined based on a first flow classifier, and a second data flow may be determined based on a second flow classifier. The WTRU may compare the unit of information to the packet filter, and if the WTRU determines that the unit of information matches the packet filter, the WTRU may associate the unit of information with the PDU set flow identifier (e.g., associate the unit of information with the PSU set association and treatment rule). The unit of information may be assigned to a PDU set, and the headers of the PDUs in the PDU set may include the determined PDU set flow identifier.

The packet filter compared against the application layer unit of information may be based on an IP 5-tuple or an application layer traffic descriptor (e.g., such as I-Frame, P-Frame, etc.).

The PDUs of a PDU set may include header information that indicates the sequence of the PDU in the PDU set. For example, information in the header may indicate that a PDU is the first PDU in a PDU Set that includes 5 PDUs.

If multiple units of information match the same packet filter and are assigned to a PDU set identifier (e.g., the same PDU set identifier), the corresponding PDU sets may be called a PDU set flow, as shown in FIG. 2.

Different PDU set flows may be synchronized within a synchronization threshold. PDU set flows associated with different PDU set identifiers may be (e.g., may need to be) synchronized. PDU set association and treatment rules may include information (e.g., synchronization information) that indicates to the WTRU which PDU set flows (e.g., which may be identified with a PDU set identifier) to synchronize (e.g., need to be synchronized). The PDU set association and treatment rules (e.g., synchronization information) may indicate a synchronization threshold for the PDU set flows and a synchronization group identifier.

The WTRU may populate the header of the PDUs of a PDU set with the synchronization group identifier and the PDU set flow identifier. The UPF may use the synchronization group identifier and/or the PDU set flow identifier to detect which PDU sets may be used to perform synchronization measurements, which PDU sets may be synchronized, and which PDU sets the UPF may delay to improve synchronization measurements. To reduce the amount of information to be transmitted (e.g., the amount of information that needs to be transmitted), the WTRU may choose to populate (e.g., only populate) the header of the PDU in a PDU set with the synchronization group identifier.

In an example, multiple WTRUs may transmit flows that may be part of a synchronization group (e.g., the same synchronization group). The multiple WTRUs may populate the PDU headers with a synchronization group identifier (e.g., the same synchronization group identifier). The UPF may use this information to synchronize PDU sets as described herein. The UPF may use measurement information received from a first WTRU to determine how to synchronize (e.g., to determine a delay for) PDUs transmitted from a second WTRU.

The WTRU may provide the SMF with information that indicates which PDU set flows are associated with the same synchronization group identifier. This information may be sent to the SMF in a NAS-SM message, such as a PDU session modification command or a PDU session establishment request. In examples, the AF may provide the information to the SMF. If the AF provides the information to the SMF, the information may be sent via a network exposure function (NEF) and/or policy control function (PCF) service invocations. The SMF may use this information to detect which flows to synchronize (e.g., which flows need to be synchronized), thereby removing the need for the WTRU to add the synchronization group identifier in the header.

The PDU header may be populated in the downlink. The UPF may receive IP packet(s) from a data network in the downlink. The IP packet(s) may have originated from an application server. The UPF may be configured with packet detection rules that detect which IP packets are part of the same unit of information. The packet detection rules may be enhanced to include a PDU set flow identifier, which may be associated with the unit of information and may be assigned to the PDUs of the PDU set that carries the unit of information to the WTRU. The UPF may populate the PDU header with the PDU set flow identifier.

The packet detection rules (e.g., or a reference to the packet detection rules) may be received by the UPF in an N4 message (e.g., N4 session modification request) from the SMF that serves the PDU session associated with the application that generated the unit of information. The packet detection rules may include a packet filter and/or a PDU set flow identifier (e.g., a flow classifier). The UPF may compare the IP packets to the packet filter. If the WTRU determines that the unit of information matches the packet filter, the WTRU may associate the unit of information with the PDU set flow identifier. The unit of information may be assigned to a PDU set, and the headers of the PDUs in the PDU set may include the determined PDU set flow identifier.

The packet filter compared against the IP packets may be based on an IP 5-tuple and/or an application layer traffic descriptor (e.g., such as I-Frame, P-Frame, etc.).

The PDUs of a PDU set may include header information that indicates the sequence of the PDU in the PDU set. For example, information in the header may indicate that a PDU is the first PDU in a PDU set that includes five (5) PDUs.

If multiple units of information match the same packet filter and are assigned the same PDU set identifier, the corresponding PDU sets may be called a PDU set flow, as shown in FIG. 2.

Different PDU set flows may be synchronized within a synchronization threshold. PDU set flows associated with different PDU set identifiers may be synchronized (e.g., may need to be synchronized). The packet detection rules may be enhanced to include information that indicates to the UPF the PDU set flows, which are identified with a PDU set identifier and/or which may be synchronized. The packet detection rules (e.g., synchronization information) may indicate a synchronization threshold for the PDU set flows and a synchronization group identifier.

The UPF may populate the header of the PDUs of a PDU set with the synchronization group identifier. The WTRU may use the synchronization group identifier to detect which PDU sets may be used to perform synchronization measurements, which PDU sets may be synchronized, and which PDU sets the WTRU access stratum may delay to improve synchronization measurements. To reduce the amount of information transmitted (e.g., the amount of information that needs to be transmitted), the UPF may choose to populate (e.g., only populate) the header of the PDU in a PDU set with the synchronization group identifier.

A WTRU may detect and/or notify the network of a synchronization status, for example, to improve the quality of experience.

Feature(s) associated with a NAS notification are provided. A WTRU may detect that data from a flow that the WTRU is transmitting and/or receiving is not synchronized (e.g., sufficiently synchronized) with a second flow. The second flow may be associated with the WTRU or a second WTRU.

In examples, a WTRU application that is hosted in the terminal equipment (TE) part of the WTRU may detect that a flow is not synchronized (e.g., sufficiently synchronized) and may cause buffer overflow or underflow. The WTRU application may provide the synchronization information to the mobile termination (MT) part of the WTRU. The MT part of the WTRU may associate the synchronization information with the PDU session used by the WTRU application. The MT part of the WTRU may associate the synchronization information with an IP 5-tuple and/or QoS flow of the PDU session.

The WTRU may send the synchronization information and the identities of the associated PDU session, IP 5-tuple, and/or QoS flow to the network (e.g., so that the network may take actions to improve the synchronization status of the flow).

In examples, the WTRU may send the synchronization information and the information about the associated PDU session, IP 5-tuple, and/or QoS flow to the network via a NAS-SM message. The message may be received by the SMF associated with the PDU session. The SMF may use the information to perform one or more actions, such as sending updated QoS rules to the WTRU and/or QoS enforcement rules (QER) to the UPF. The SMF may forward the synchronization information to the PCF (e.g., so that the PCF may update policy charging and control (PCC) rules and/or UE route selection policy (URSP) rules). The SMF may forward the synchronization information to the NWDAF so that the NWDAF may consider the synchronization information when generating network data analytics.

In examples, the synchronization information received by the SMF may relate to flows that may be part of a multi-modal session with flows that may be associated with one or more WTRUs (e.g., other WTRUs). The SMF may use the synchronization information to determine whether to send updated QoS rules to one or more WTRUs (e.g., other WTRUs) and whether to send updated QERs to a UPF for the flows of other WTRUs.

In examples, the WTRU may be triggered to send the synchronization information by request from the application layer. Other events may trigger the WTRU to send the synchronization information. The WTRU may receive configuration information that may be used to determine when to send synchronization reports. For example, the WTRU may receive the configuration information via a NAS-SM message from the SMF. The configuration information may be associated with a PDU session. The configuration information may include one or more of the following fields. The fields may include a time value that indicates how often the WTRU may send synchronization reports when the PDU session is active (e.g., the WTRU is in the CM-CONNECTED state). The fields may include packet filters indicating which IP flows synchronization reports may be sent. The packet filters may be based on an IP 5-tuple, a PDU set identifier, packet type (e.g., I-frame or P-frame), or a combination thereof. The fields may include a synchronization threshold that indicates to the WTRU that synchronization information is to be sent (e.g., only needs to be sent) when a synchronization measurement meets and/or exceeds a threshold. A PDU session modification request may be generated (e.g., either network- or WTRU-initiated) for the PDU session being used by the multi-modal application. Generating the PDU session modification request may trigger the WTRU to send the synchronization information. QoS flows (e.g., certain QoS flows) that carry application traffic may change their characteristics. Changing the characteristics of the QoS flows may trigger the WTRU to send the synchronization information. Data traffic (e.g., data traffic other than multi-modal traffic) that is carried within a certain QoS flow (that is shared with the multi-modal traffic) may trigger (e.g., be the source of) the PDU session modification request. In such a case, the network may ask the WTRU to send (e.g., or the WTRU may independently determine to send) the synchronization information to the network to assess if the synchronization between multi-modal flows is synchronized (e.g., within the synchronization threshold).

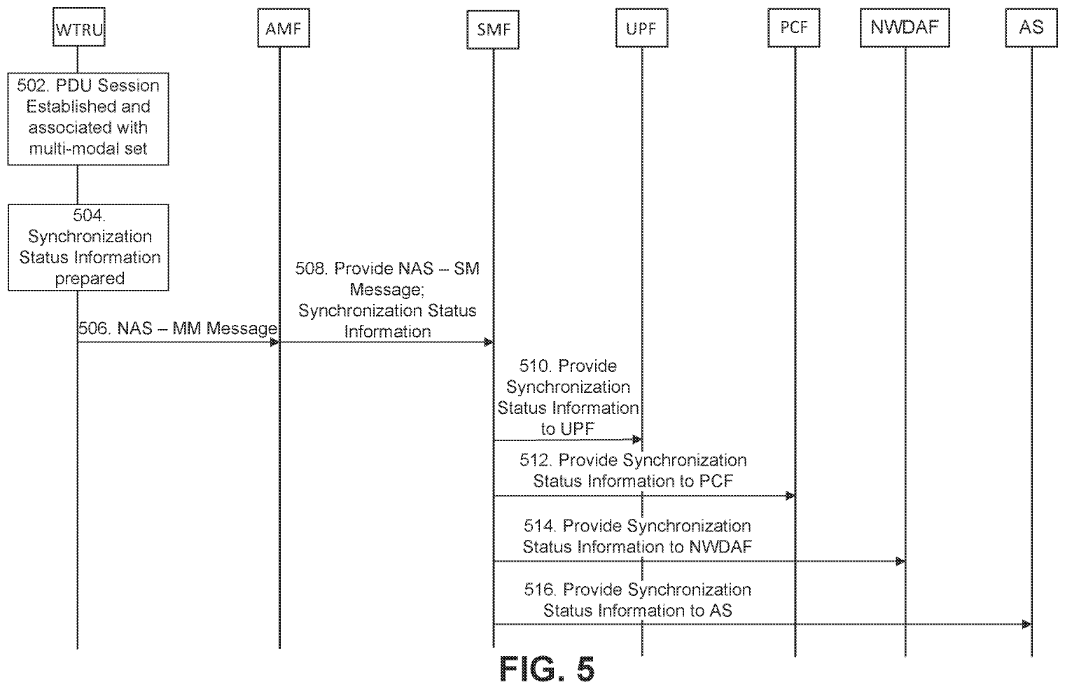

FIG. 5 shows an example of a NAS-based synchronization status notification.

As described with respect to FIG. 5, at 502, a WTRU-hosted application may trigger the establishment of a PDU session. The WTRU-hosted application may provide a traffic descriptor or XRM session identifier to the MT part of the WTRU. When the PDU session is established, the WTRU may provide the traffic descriptor or XRM session identifier to the network (e.g., so that the network may determine what other PDU sessions and/or flows are associated with the PDU session). The other PDU sessions and/or flows may be associated with other WTRUs. Once the PDU session is established, the WTRU-hosted application (e.g., an XR application) may begin to send and/or receive multi-modal data. When the PDU session is established, the MT part of the WTRU may provide the WTRU-hosted application with an identifier associated with the PDU session. For example, the identifier associated with the PDU session may be a context identifier (CID).

As described with respect to FIG. 5, at 504, a WTRU-hosted application may determine information about the synchronization status of flow(s) associated with the application. Example information associated with the synchronization status of flow(s) are listed in Table 1. The WTRU-hosted application may send the information associated with the synchronization status of flow(s) to the MT part of the WTRU. For example, the WTRU-hosted application may invoke an AT command to provide information about the synchronization status of flow(s) to the MT part of the WTRU. When the WTRU-hosted application provides the information about the synchronization status of flow(s) to the MT part of the WTRU, the WTRU-hosted application may provide the XRM session identifier, traffic descriptor, and/or an identifier that is associated with the PDU session to the MT part of the WTRU. For example, the identifier associated with the PDU session may be a context identifier.

The synchronization status information provided herein may indicate whether or not a flow is properly synchronized. The synchronization status information may indicate the degree to which a flow is or is not properly synchronized (e.g., the information may indicate that data is arriving, on average, 1 ms too early or too late). The WTRU-hosted application may not be responsible for determining whether a flow is synchronized. The WTRU-hosted application may report (e.g., only report) information about flow(s) so that another entity (e.g., network or application server) may determine whether the flow(s) are synchronized, and the degree to which the flow is (or is not) synchronized. The synchronization status information may include information that may be used by the network, or an application server, to determine whether the flow(s) are synchronized and the degree to which the flow(s) are or are not properly synchronized. Table 1 shows examples of the information that may be included in the synchronization status information.

The synchronization status information may be based on a measurement. The measurement may be performed at the WTRU. For example, the WTRU may measure the difference in arrival or transmission time of the associated PDUs (e.g., a difference measurement) and use this measurement as a synchronization measurement. The difference measurement may be between the arrival time, or transmission time, of the first PDUs of two PDU sets or a burst of PDU sets. A burst of PDUs may be a number of PDUs sent at similar times or at the same time. The difference measurement may be between the arrival time or transmission time of the last PDUs of two PDU sets or a burst of PDU sets.

The difference measurement may refer to the time difference between the arrival or transmission of the first PDUs of two PDU sets or bursts, or the time difference between the arrival or transmission of the last PDUs of two PDU sets or bursts. This time difference may be used for various purposes, such as synchronizing different data flows or analyzing the performance of a communication system.

For example, if two data flows send a burst of PDUs, the difference measurement between the arrival time of the first PDUs of the two bursts may be used to determine the latency between the data flows. The difference measurement between the arrival time of the last PDUs of the two bursts may be used to determine the latency between the data flows.

The difference measurement may also be used for analyzing the performance of a communication system. For example, if the difference measurements between two PDU sets or bursts are long, this may indicate a problem in the communication system, such as congestion or a bottleneck along the transmission path.

The difference measurement may be used to measure the differences between multiple PDU sets or bursts (e.g., in addition to measuring the time difference between two PDU sets or bursts). The difference measurement between multiple PDU sets or bursts may be used for analyzing changes in the performance of a communication system over time and measuring the effectiveness of optimization techniques. A burst of PDUs may be a number of PDUs sent at similar times or at the same time.

As described with respect to FIG. 5, at 506, the WTRU may send a NAS-MM message to the AMF. The NAS message may be triggered by the message sent during the synchronization status information preparation or by a timer configured in the NAS layer to periodically trigger the WTRU to send the NAS-MM message to the AMF. The access stratum may trigger the NAS-MM layer to send the report. The access stratum may send the trigger to the NAS layer periodically when a PDU Set is received and/or when a synchronization issue is detected. The NAS-MM message may include a NAS-SM message and/or a PDU session ID. The identifier associated with the PDU Session (e.g., cid) during the synchronization status information preparation may be used by the WTRU to determine the PDU session ID. The NAS-SM message may include the PDU session ID and/or the synchronization status information. The synchronization status information may include an identifier of the multi-modal data set (e.g., an XRM session identifier received from the WTRU hosted application). The NAS-MM message may identify one or more flows associated with the synchronization information. The flows may be identified with a synchronization group identifier, a PDU set flow identifier, an IP 5-tuple, or a QoS flow ID. The AMF may forward the NAS-SM message to the SMF. The AMF may use the PDU session ID in the NAS-MM part of the message to determine what SMF to send the NAS-SM message to. The SMF may know what XRM session identifier is associated with the PDU session due to the XRM session identifier provided during the PDU session establishment.

As described with respect to FIG. 5, at 508, the SMF may receive the synchronization status information. The SMF may use the synchronization status information to trigger one or more of the following actions (e.g., which may improve the overall quality of experience of the WTRU-hosted application and/or the overall quality of experience of applications hosted on other WTRU associated with the WTRU-hosted application). The SMF may receive synchronization status information from multiple WTRUs (e.g., the other WTRUs that are part of the multi-modal data set). The SMF may use the synchronization status information from multiple WTRUs to determine what actions to trigger and how to configure such actions. For example, the SMF may use multiple reports to derive QoS rules and delay information. The actions may include the SMF using the synchronization status information to derive Qos rules for the PDU session and sending the QoS rules to the WTRU and/or to the radio access network (RAN) node.

The SMF may use the synchronization status information to derive QoS rules for the PDU session(s) of other WTRU(s) (e.g., the other WTRUs that host applications that are part of the same multi-modal data set). The actions may include the SMF using the synchronization status information to derive QER(s) and forwarding the QER(s) to a UPF associated with the PDU session. The SMF may use the synchronization status information to derive QER(s) for the PDU session(s) of other WTRU(s) (e.g., the other WTRUs that host applications that are part of the same multi-modal data set). The actions may include the SMF using the synchronization status information to derive a data delay value. The data delay value may be sent to a UPF associated with the PDU session. The UPF may apply the data delay value to uplink or downlink traffic from the PDU session.

The SMF may provide separate delay values for uplink and downlink traffic. The SMF may provide delay values specific to flow(s) (e.g., certain flow(s) of the PDU session. The delay values may be configured per IP 5-tuple. The SMF may use the synchronization status information to derive data delay values for traffic that is associated with the PDU session(s) of other WTRU(s) (e.g., the other WTRUs that host applications that are part of the same multi-modal data set). The actions may include the SMF forwarding the synchronization status information to a PCF. The actions may include the SMF forwarding the synchronization status information to an NWDAF. The actions may include the SMF forwarding the synchronization status information to an application server and/or application function. The information may be sent to the application server and/or application function via a NEF.

As described with respect to FIG. 5, at 510, the UPF may receive synchronization status information from the SMF. The UPF may use the synchronization status information to determine what QoS treatment to apply to downlink data, whether to apply processing delays to downlink and/or uplink traffic and/or how much processing delay to apply to downlink and/or uplink traffic.

As described with respect to FIG. 5, at 512, the PCF may receive synchronization status information from the SMF. The PCF may use the synchronization status information to derive PCC rules and/or URSP rules. The PCC rules and/or URSP rules may be associated with the WTRU that sends the synchronization status information and may be associated with other WTRUs that are associated with the same multi-modal data set. As described herein, the synchronization status information may include an XRM session identifier of the multi-modal data set. The PCF may use the XRM session identifier to determine which PDU sessions and WTRUs are associated with the multi-modal data set.

As described with respect to FIG. 5, at 514, the NWDAF may receive synchronization status information from the SMF. The NWDAF may use the synchronization status information to compute data analytics. For example, the NWDAF may use the synchronization status information to compute analytics related to the quality of experience.

As described with respect to FIG. 5, at 516, an AS may receive synchronization status information from the SMF. The AS may receive the synchronization status information via the NEF. The AS may use the synchronization status information to trigger one or more actions described herein (e.g., such as adjusting QoS of flows that are associated with the multi-modal data set by invoking a NEF API such as Nnef_Trafficinfluence). The AS may use the synchronization status information to adjust application traffic (e.g., by changing codec settings, frame rates, etc.). The actions may include the AS sending the synchronization status information to the PCF. The synchronization status information may be sent to the PCF via the NEF. The AS may provide the NEF with an XRM session identifier, and the NEF may use the XRM session identifier to query a binding support function (BSF) to determine which PCF(s) may receive the synchronization status information. As described herein, the PCF may use the synchronization status information to take actions to improve the quality of experience (e.g., update PCC rules that trigger the SMF to request that the UPF adjust the delay that is applied to some flow(s), etc.). The actions may include the AS sending the synchronization status information to the NWDAF. The synchronization status information may be sent to the NWDAF via the NEF. As described herein, the NWDAF may use the synchronization status information when calculating data analytics, such as, for example, quality of experience information. The actions may include the AS triggering changes to the application layer traffic (e.g., such as changing codec settings, frame rates, etc.).

The synchronization status information that the AS receives may be associated with a flow that is part of a multi-modal set. Changes to the flow that the AS may trigger may impact other flows in the multi-modal set. The other flows in the multi-modal set may be associated with other WTRUS.

As described herein, the SMF, NWDAF, PCF, and AS/AF may receive synchronization status information and/or trigger actions based on the synchronization status information. In examples, the synchronization status information may be sent to a network function or server that indicates (or configures) action(s) for the SMF, PCF, and/or NWDAF to take. The network function or server may indicate (or configure) actions for other network functions to improve the overall quality of experience. Such network functions may include a QoE monitoring network function.

After sending the NAS-MM message described herein (e.g., at 506 in FIG. 5), the WTRU may trigger synchronization status information preparation. Triggering synchronization status information preparation may cause the WTRU to begin calculating how flows are synchronized (e.g., the WTRU may perform the procedure at 504 in FIG. 5). The WTRU may send a NAS-MM message if the WTRU determines that synchronization information is to be sent (e.g., needs to be sent) to the network again (e.g., the WTRU may perform the procedure at 506 in FIG. 5).

As described herein, synchronization status information may be sent to the SMF by the WTRU. In examples, the network may include a synchronization report repository function (SRRF). The WTRUs may send the synchronization status information to the SRRF. The SRRF may calculate the degree to which flows are, or are not, synchronized and may send guidance information to the SMF that may be used to calculate the QoS rules and/or delay values described herein.

Feature(s) associated with a user plane notification are provided. As shown in FIG. 5, the WTRU may use NAS signaling to send synchronization status information to a network function(s) and/or an application server (e.g., so that the network function(s) and/or application server may take actions to improve overall user experience).

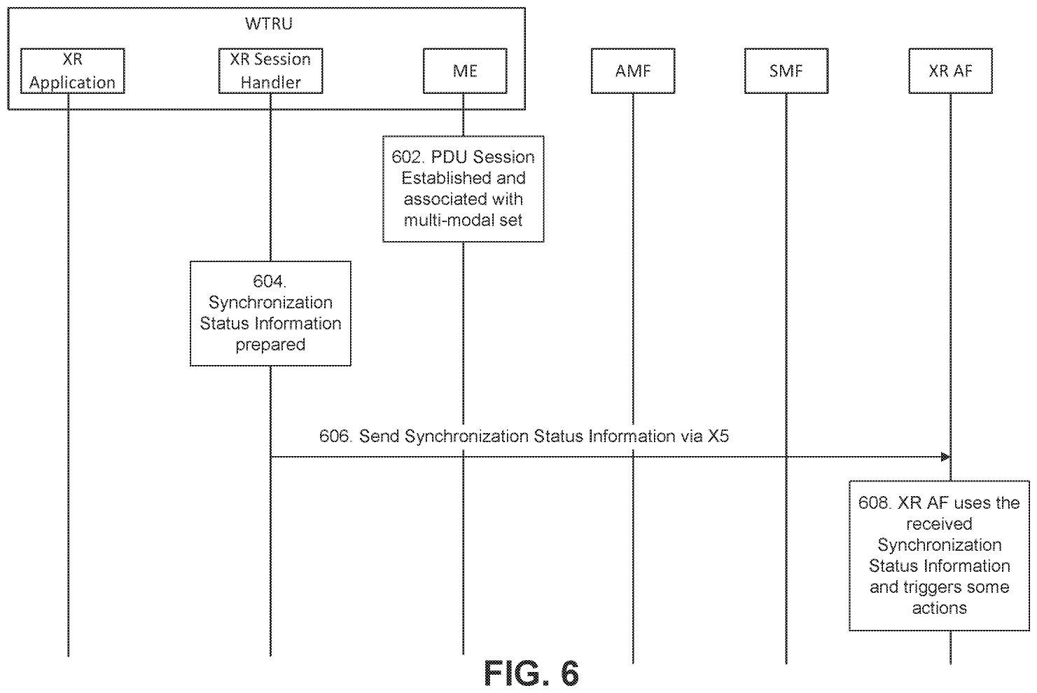

FIG. 6 shows an example of an X5-based synchronization status notification. As shown in FIG. 6, the synchronization status information may be sent to the network via user plane signaling. The user plane signaling may terminate at an application server and/or the application server may forward the synchronization status information to network function(s) and/or trigger network function(s) to take action to improve the overall quality of experience. In examples, the X5 interface may be enhanced to allow the WTRU-hosted application to send synchronization status information over the user plane.

As described with respect to FIG. 6, at 602, a WTRU-hosted application such as an XR (e.g., a 5GXR) application may trigger the establishment of PDU session. The WTRU-hosted application may use the PDU session to send and/or receive data flows that are part of a multi-modal data set. Other applications (e.g., other XR Applications) may send and/or receive data flows that are part of the multi-modal data set. The other applications may be hosted on other WTRUs.

As described with respect to FIG. 6, at 604, a WTRU hosted application (e.g., the XR session handler) may determine synchronization status information of flow(s) that are associated with the application. Examples of synchronization status information of flow(s) are listed in Table 1.

The synchronization status information provided herein may indicate whether or not a flow is synchronized (e.g., properly synchronized). The synchronization status information may indicate the degree to which a flow is or is not properly synchronized (e.g., the information may indicate that data is arriving, on average, 1 ms too early or too late). The WTRU-hosted application may not be responsible for determining whether or not a flow is synchronized. The WTRU-hosted application may report (e.g., only report) information about flow(s), for example, so that another entity (e.g., network or application server) may determine whether a flow is synchronized and the degree to which a flow is or is not synchronized. The synchronization status information may include information that may be used by the network, or an application server, to determine whether or not a flow is synchronized and the degree to which a flow is or is not synchronized. Table 1 shows examples of information that may be included in the synchronization status information.

As described with respect to FIG. 6, at 606, the WTRU-hosted application may send synchronization status information to an application server (e.g., an XR AF). The synchronization status information may include, or be sent with, an XRM session identifier associated with the multi-modal data flows. As described herein, the information from Table 1 may be included in the synchronization status information.

At 608, the application server (AS) may receive the synchronization status information. The AS may use this information to trigger one or more of the following actions (e.g., which may improve the overall quality of experience of the WTRU-hosted application and may improve the quality of experience (e.g., the overall quality of experience) of applications that are hosted on other WTRUs and associated with the WTRU-hosted application). The action(s) may include the AS sending the synchronization status information to the PCF. The information may be sent to the PCF via the NEF. The AS may provide the NEF with an XRM session identifier, and the NEF may use the XRM session identifier to query a BSF to determine which PCF(s) may receive the synchronization status. As described herein, the PCF may use the synchronization status information to take action(s) to improve the quality of experience (e.g., update PCC rules that trigger the SMF to request that the UPF adjust the delay applied to some flow(s), etc.). The action(s) may include the AS sending the synchronization status information to the NWDAF. The information may be sent to the NWDAF via the NEF. As described herein, the NWDAF may use the synchronization status information to calculate data analytics (e.g., such as quality of experience information). The action(s) may include the AS triggering changes to the application layer traffic (e.g., such as changing codec settings, frame rates, etc.).

The AS may receive synchronization status information from multiple WTRUs (e.g., the other WTRUs that are part of the multi-modal data set). The AS may use the synchronization status information from multiple WTRUs to determine what action(s) to trigger and how to configure the action(s) that may be triggered. For example, the AS may use multiple reports to derive QoS rules and/or delay information.

For example, the AS may receive synchronization status information from one WTRU and use the synchronization status information to adjust the settings associated with a second WTRU (e.g., a different WTRU) that is part of the multi-modal set (e.g., the same multi-modal set), For example, the AS may use the synchronization status information from a first WTRU to determine to invoke a NEF/PCF API that reconfigures the QoS requirements of flows associated with a second WTRU.

Examples of the content of the synchronization status information are provided. The synchronization status information may include identifying information that may be used to associate the information with WTRU(s), PDU session(s), and/or data flow(s) that are part of the same multi-modal data set. The identifying information may be an XRM session identifier. Data flow(s) may be identified with an IP 5-tuple. PDU session(s) may be identified with a PDU session ID. WTRU(s) may be identified by an IMSI, SUCI, or external identifier.

As described herein, information from the application layer may be part of the notification. For example, the synchronization status information may be based on a real-time control protocol (RTCP). An RTCP sender/receiver may report a packet number and/or an octet number. The report may include a timestamp and may be used to derive the synchronization status information. For example, the packet number may be used to derive a PDU set number, and/or the headers of the PDUs in the PDU set may have a field populated with an RTCP packet number. For example, the WTRU-hosted application may use an application programming interface (API) or an attention (AT) command to provide synchronization status information that includes the timing of the first and/or last packet of a received or sent PDU set (e.g., any received or sent PDU set). For example, an RTCP media stream correlation identifier or SyncGroupId may be used to derive the synchronization group identifier in the synchronization status information.

Information (e.g., additional information) may be part of synchronization status information. In examples, the information from Table 1 may be derived from the access stratum. For example, the access stratum may detect presentation times, PDU set arrival times, and/or synchronization error values. Information from the access stratum may be provided with a PDU session ID and/or a PDU set flow identifier (e.g., so that the NAS layer may determine the flows associated with the report).

TABLE 1

| Information Element | Description / Examples |
|---|---|
| XRM session identifier | The XRM session identifier may identify information that may be used to |
| | associate the rest of the information in this table with WTRU(s), PDU |
| | session(s), and/or data flow(s) that are part of the multi-modal data set |
| | (e.g., the same multi-modal data set). |
| Presentation time | Presentation time may be used to synchronize an application's separate |
| | (e.g., single-modal) data streams (e.g., audio, video, haptic, and/or |
| | subtitles) when the media are presented to the user. Presenting to the user |
| | may include a video frame displayed on a display, sound played out |
| | through speakers, haptic information conveyed through actuation, and/or |
| | the like. Presentation time may be a time stamp that temporally interrelates |
| | elements between streams, and the streams may be scheduled at the |
| | application layer based on this time stamp when presenting to the user. |
| | Presentation time may be embedded into media streams (e.g., RTP stream |
| | and/or meta data field in a MPEG stream). Presentation time may be |
| | applied at the PDU set (e.g., time data in a PDU set being presented to the |
| | user) or at media unit (e.g., time data in a media unit being presented to the |
| | user) levels. |
| PDU set arrival/received | The PDU set arrival/received time may be the timestamp that specifies the |
| time | time the WTRU has received a specific PDU set. The PDU set may be |
| | identified with one or more of an XR session ID, a PDU set identifier, and/or |
| | a synchronization group identifier. |
| Payload/content type | The payload/content type may indicate the type of data associated with the |
| | synchronization information (e.g., audio, video, and/or haptic). This |
| | information may be helpful because synchronization threshold requirements |
| | may differ per the type (e.g., each type) of mode. The payload/content type |
| | may be sent (e.g., along with timing information). |
| Synchronization error | Synchronization error calculations may indicate the time difference between |
| calculations | two data flows (e.g., any two data flows, such as audio-video and video- |
| | haptic). Per the flows (e.g., each flow) of data being used by the |
| | application, the synchronization error value may be calculated. The PDU |
| | set arrival/received time and/or the presentation time may be used for |
| | calculating this value. In examples, synchronization error values of PDU set |
| | arrival/received time and presentation times may be used. If one or more |
| | flows are distributed among other WTRUs, a single WTRU may |
| | receive/collect PDU set arrival/received time or the presentation time |
| | information from other WTRUs for calculating this value(s). The flows may |
| | be identified with a PDU set flow identifier, a synchronization group |
| | identifier, or an IP 5-tuple. |
| Synchronization | This information may be collected via device-to-device communications and |
| information that was | may indicate the degree to which two or more flows are synchronized. The |
| collected from other | information may be expressed in units of time. The flows may be identified |
| WTRUs | with one or more of a WTRU identifier, XR session ID, a PDU set identifier, |
| | and/or a synchronization group identifier. The WTRU identifier may be a |
| | GPSI, IP Address, or a S-TMSI. |
| Information about buffer | This information may indicate the number, or frequency, of buffer overflow |
| overflow or underflow | or underflow events. The information may be associated with a flow |
| events | identifier (e.g., a PDU set flow or an IP 5-tuple). |

Feature(s) associated with synchronizing flows are provided. Synchronizing at the UPF via SMF provided delays may be provided.

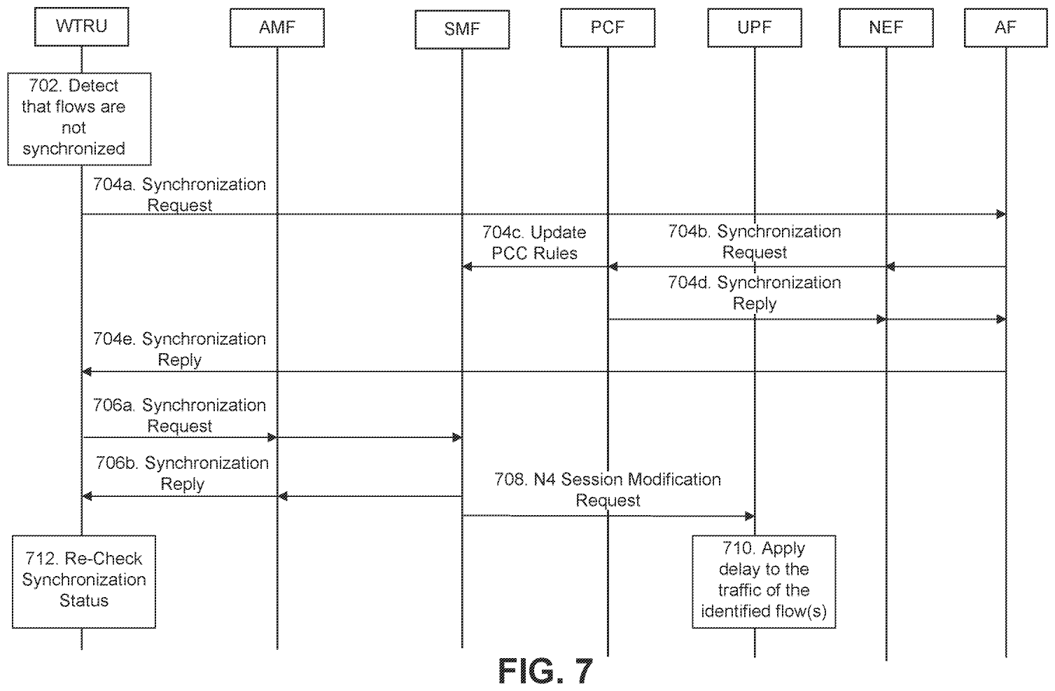

In examples, the system may improve the synchronization of flows (e.g., may prevent flows from becoming asynchronous) by the SMF configuring the UPF to introduce a delay to one or more flows to make one or more flows synchronized with other flows, as illustrated in FIG. 7. FIG. 7 illustrates an example of synchronizing flows at the UPF via SMF-provided delays. The SMF may send an N4 message to the UPF to configure the UPF to introduce a delay to one or more flows. The N4 message may be an N4 session modification request that is enhanced to allow the SMF to identify one or more flows and a desired delay, or a range of delays, for the identified flows. The flows may be identified with an IP 5-tuple.

In an example, a WTRU may receive one or more synchronization rules for a PDU data set flow (e.g., a flow). The synchronization rule may specify a PDU data set flow associated with one or more functions and/or services. The synchronization rule may specify the order in which the WTRU performs and/or analyzes the synchronization of the one or more flows.

In an example, a WTRU may receive synchronization information associated with a PDU session. The PDU session may include one or more flows, such as a PDU data set flow. Synchronization information may include one or more synchronization rules, which may be the criteria used to determine when and how data may be synchronized between two or more data flows. Synchronization rules may define the type of data flows that should be synchronized, when and how often the data flows may be synchronized, and the order in which data flows may be synchronized. Synchronization rules may also specify details such as the protocols to be used for data transfer, the user credentials to be used to access the data, the frequency of the synchronization process, thresholds for synchronization, thresholds for asynchronization, values of synchronization, values of asynchronization, levels of synchronization, levels of asynchronization, and/or the like.

As described with respect to FIG. 7, at 702, the WTRU may detect that a first flow is not synchronized with one or more other flows. For example, the WTRU may detect that a first flow may be asynchronous with one or more other flows. This detection may be performed in the access stratum part of the WTRU. The access stratum part of the WTRU may receive information from the NAS part of the WTRU that indicates which flows may be synchronized and a synchronization threshold value that indicates the degree to which the flows are to be synchronized (e.g., one or more flows may be asynchronous and may need to be synchronized). The access stratum may use information from the NAS part of the WTRU to determine whether a flow may be synchronized with one or more other flows (e.g., the flow may be asynchronous with the one or more flows). When the access stratum determines the synchronization status of the flow with regards to the one or more flows, the access stratum may send an indication to the NAS part of the WTRU to indicate that the first flow is synchronized with one or more other flows, or is not synchronized with one or more flows (e.g., is asynchronous with one or more flows). The indication from the access stratum may identify the flow with a PDU set flow ID, IP 5-tuple, and/or a QoS flow ID.

In an example, a synchronization measurement may be determined using the synchronization information. The synchronization measurement may indicate a level of synchronization between a first data flow and a second data flow. The first data flow and the second data flow may be associated with a PDU session. The WTRU may determine that the first data flow and the second data flow are asynchronous based on a threshold. For example, the WTRU may determine that the first data flow and the second data flow are asynchronous when the synchronization measurement is above a threshold. As another example, the WTRU may determine that the first data flow and the second data flow are asynchronous when the synchronization measurement is below a threshold.

As described with respect to FIG. 7, at 704a-704e, in a first option, the WTRU may send a synchronization request message to an application server, as described herein. The request message may indicate a value of synchronization, may indicate that one or more flows are asynchronous, may indicate a value of asynchronization, may indicate a request to synchronize one or more flows, a combination thereof, and/or the like. As described with respect to FIG. 7, at 704a, the WTRU may send an application layer message to an application server (e.g., AF) to indicate that the first flow is not synchronized with one or more other flows. The message may identify the flow (e.g., identify with an IP 5-tuple) and indicate a delay value or a range of delay values that may be applied to the traffic to synchronize the flow. For example, the message may include the information from Table 1. The message may indicate if the delay may be introduced on the downlink traffic, uplink traffic, or both. In examples, the message may be sent within the flow to be synchronized (e.g., the flow that may be identified as asynchronous and/or may need to be synchronized), and the application server may determine that the flow that the message was received on is to be synchronized (e.g., the flow may have been identified as asynchronous and/or may need to be synchronized). The message may include the information (e.g., any of the information) from Table 1 (e.g., so that the application server may use the information from Table 1 to determine what delay value(s) to apply and to which flows the delay value(s) should be applied).

As described with respect to FIG. 7, at 704b, the application server may send a message to the network to request that the network introduce the delay to the flow that was identified in the synchronization request procedure described herein (e.g., at 704a in FIG. 7). The request may be sent to the NEF. The NEF may use the BSF to determine which PCF serves the PDU session and may forward the request to the PCF. The application server may send a message to the network to request that the network introduce a delay to another flow that is part of the multi-modal set (e.g., the same multi-modal set) as the identified flow (e.g., the flow identified at 704a). The other flow may be associated with a different WTRU.

As described with respect to FIG. 7, at 704c, the request from the AS/NEF may trigger the PCF to send updated PCC rules to the SMF.

As described with respect to FIG. 7, at 704d, the PCF may respond to the application server by indicating whether the request delay may be applied. If the PCF indicates that the delay may not be applied, the application server may attempt to take a different action to improve the quality of experience (e.g., adjust a codec setting and/or frame rate).

As described with respect to FIG. 7, at 704e, the application server may respond to the WTRU-hosted application with an indication of whether the request delay may be applied. If the application server indicates that the delay may not be applied, the WTRU-hosted application may attempt to take a different action to improve the quality of experience (e.g., adjust a codec setting and/or frame rate).

As described with respect to FIG. 7, at 7063a-706b, in a second option, the WTRU may send a synchronization request to the SMF as described herein. The WTRU may use both options concurrently, for example, sending one or more synchronization requests to the application server(s) and one or more synchronization requests to SMF(s).

As described with respect to FIG. 7, at 706a, the WTRU may send a NAS-SM message to the SMF that serves the PDU session of a first flow. The NAS-SM message may indicate that the first flow is not synchronized with one or more other flows. The message may identify the flow (e.g., identify the flow with a synchronization group identifier, a PDU set flow identifier, an IP 5-tuple, or a QoS flow ID) and may indicate a delay value or a range of delay values that may be applied to the traffic to synchronize the flow. The message may indicate if the delay may be introduced on the downlink traffic, uplink traffic, or both. The message may include the information (e.g., any of the information) from Table 1 (e.g., so that the SMF may use the information from Table 1 to determine what delay value(s) to apply and to which flows the delay value(s) should be applied).

In an example, a message may be sent to a network node indicating that the first data flow and the second data flow are asynchronous (e.g., not synchronized). The message may indicate a correction factor (e.g., how to adjust the first data flow and/or the second data flow).

As described with respect to FIG. 7, at 706b, the SMF may respond to the WTRU by sending a synchronization reply indicating whether or not the request delay may be applied. If the SMF indicates that the delay may not be applied, the MT part of the WTRU may provide the indication to the WTRU-hosted application. The WTRU-hosted application may attempt to take a different action (e.g., other than applying the request delay) to improve the quality of experience (e.g., adjust a codec setting, frame rate, delay a flow, and/or provide a QoS rule).

As described with respect to FIG. 7, at 708, the SMF may send an N4 message to the UPF to configure the UPF to introduce a delay to one or more flows. The N4 message may be an N4 session modification request that is enhanced to allow the SMF to identify one or more flows and a desired delay, or range of delays, for the identified flow(s). The flows may be identified with an IP 5-tuple.

As described with respect to FIG. 7, at 710, the UPF may apply a delay to the identified flow(s) as requested via the synchronization request.

As described with respect to FIG. 7, at 712, the WTRU-hosted application may measure (e.g., measure again) how a first flow is synchronized with one or more other flows (e.g., re-check the synchronization status of flows) and determine whether to send another request to the network to synchronize the flows.

As described herein, a UPF may perform procedures to obtain information about the synchronization status of flows and use this information to determine whether to apply delays to PDU set(s). These procedures may also be performed by a base station, such as a gNB.

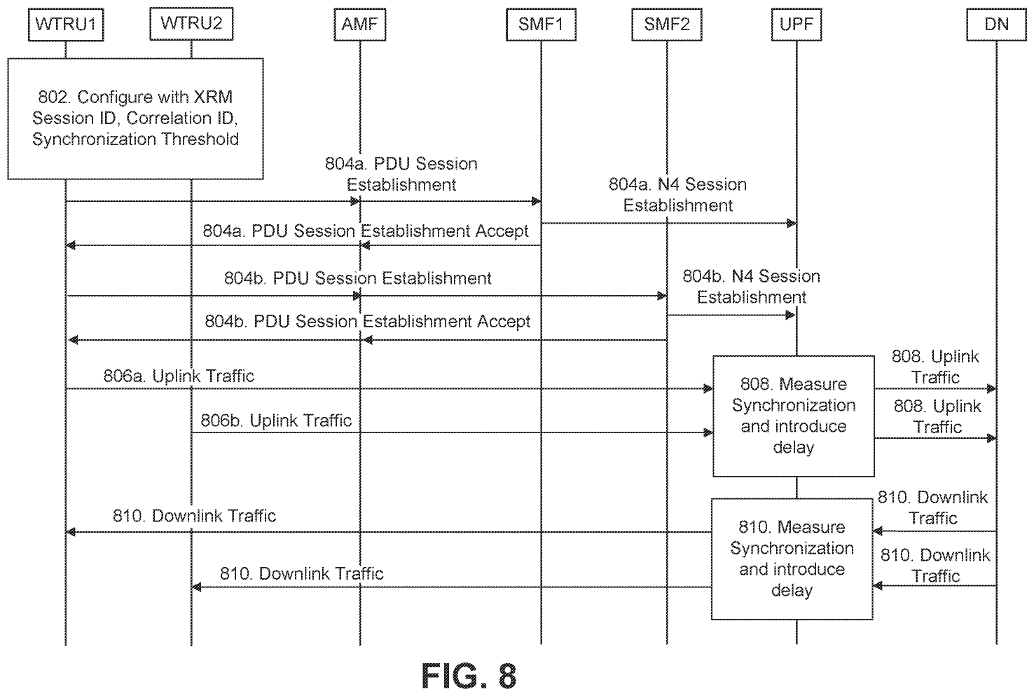

Feature(s) associated with synchronizing flows at the UPF via UPF-derived delays are provided. In examples, a system may improve the synchronization of flows by the SMF configuring the UPF to synchronize one or more flows, as illustrated in FIG. 8. FIG. 8 illustrates an example of synchronizing flows at the UPF via SMF-provided delays. The SMF may send an N4 message to the UPF to request that the UPF synchronize one or more flows. The N4 message may be an N4 session modification request sent from the SMF to the UPF. The N4 message may be enhanced to allow the SMF to identify two or more flows and a desired synchronization threshold for the identified flows. The UPF may detect which PDUs of the identified flows to synchronize (e.g., need to be synchronized). When the UPF sends an uplink or downlink PDU of a first flow, the UPF may detect or measure how well the PDU of the first flow is synchronized with a PDU of a second flow. In examples, the UPF may perform the detection, or measurement, on PDU sets. For example, the UPF may detect or measure how well (e.g., on average) the PDU sets of a first flow and the PDU sets of a second flow are synchronized. In examples, the UPF may measure how well the last PDU of a PDU set of a first flow and the last PDU of a PDU set of a second flow are synchronized.

In examples, the PDUs of a PDU set may include header information used by the UPF to detect that PDUs are part of the same PDU set or different PDU sets. PDU sets may include header information that the UPF may use to detect that PDU sets may be synchronized. For example, a PDU of a PDU set may include a synchronization group identifier field. The UPF may use the synchronization group identifier to detect that a first PDU set may be synchronized with a second PDU set. The first and second PDU sets may be associated with flows of the same WTRU or different WTRUs. Other PDU sets (e.g., other than the first and second PDU set) may be part of a different flow and may not need to be synchronized with any particular traffic. The synchronization group identifier field may be encoded in a PDU of a PDU set (e.g., only one PDU of each PDU set). When the UPF detects that two or more PDU sets have the same synchronization group identifier, the UPF may measure the difference in arrival or transmission time of the associated PDUs and use this measurement as a synchronization measurement. The measurement may be the difference between a PDU from a first PDU set and a PDU from a second PDU set. For example, the difference measurement may be between the arrival time or transmission time of the first PDUs of two PDU sets. For example, the difference measurement may be between the arrival time or transmission time of the last PDUs of two PDU sets or PDU set bursts.

If the UPF detects that flows are not synchronized, the UPF may introduce a delay in one or more flows to make the flows more synchronized.

If the UPF detects that flows are not synchronized, the UPF may send an N4 message to the SMF to notify the SMF of the measurement and to notify the SMF of the delay (e.g., any delay) that was introduced.

The UPF may periodically send N4 messages to the SMF to report the level of synchronization (e.g., synchronization measurements) between flows.

As described with respect to FIG. 8, at 802, one or more WTRUs may be configured with the same XRM session identifier, correlation identifier, and/or synchronization group identifier.

As described with respect to FIG. 8, at 804a, a first WTRU (labeled “WTRU1”) may establish a PDU session. The first WTRU may send a NAS-SM PDU session establishment request to a first SMF (labeled “SMF1”). The NAS-SM PDU session establishment request may include an XRM session identifier. The first SMF may use the XRM session identifier during UPF selection to ensure that the flows that are associated with the PDU session traverse a UPF that is common with other PDU sessions that are associated with the same XRM session identifier (e.g., the PDU sessions of the same WTRU or other WTRUs). The first SMF may send an N4 session establishment (or modification) request to the UPF. The N4 session establishment (or modification) request may include the XRM session identifier. The UPF may use the XRM session identifier to determine which flows may be synchronized. The first SMF may include a synchronization threshold in the N4 session establishment (or modification) request to the UPF.

As described with respect to FIG. 8, the first WTRU may include multiple XRM session identifiers in the NAS-SM PDU session establishment (or modification) request to the SMF. The XRM session identifier(s) (e.g., each XRM session identifier) may be associated with one or more flows (e.g., IP 5-tuples). The NAS-SM PDU session establishment (or modification) request may indicate which flow(s) are associated with the XRM session identifier(s) (e.g., each XRM session identifier). The SMF may provide the XRM session identifier(s) and associated flow identifier(s) to the UPF. The NAS-SM PDU session establishment (or modification) request may include a synchronization threshold for the flow(s) (e.g., each flow).

As described with respect to FIG. 8, at 804db, a second WTRU (labeled “WTRU2”) may establish a PDU session. The second WTRU may send a NAS-SM PDU session establishment request to a second SMF (labeled “SMF2”). The NAS-SM PDU session establishment request may include the XRM session identifier. Similar to the PDU session establishment described with respect to 804a, at 804b, the second SMF associated with this PDU session (e.g., SMF2) may use the XRM session identifier to select a UPF (e.g., the same UPF selected for the PDU session of the first WTRU). The SMF associated with this PDU session may provide the XRM session identifier in the N4 session establishment (or modification) request to the UPF.

As described herein, the NAS-SM PDU session establishment (or modification) request may include an XRM session identifier(s). The XRM session identifier(s) (e.g., each XRM session identifier) may be associated with one or more flows.

As described with respect to FIG. 8, at 806a, the first WTRU may begin to generate uplink traffic. As the WTRU generates uplink traffic, the NAS layer may create PDUs from the traffic. The PDUs may be associated with a PDU set and the PDUs (e.g., each PDU) may be transmitted. The PDUs (e.g., each PDU) may include a header that indicates the PDU set with which the PDU is associated. The header may include a synchronization group identifier that indicates other PDU sets with which the PDU set may be synchronized. The synchronization group identifier may be provided by the application layer when the application layer provides a packet (e.g., unit of information) for transmission.

As described with respect to FIG. 8, at 806b, the second WTRU may generate uplink traffic. PDU sets may be generated and PDUs may be sent with a header (e.g., that may include a synchronization group identifier to indicate the PDU set with which the PDU is associated).

As described with respect to FIG. 8, at 808, packets sent to the uplink traffic procedures described herein (e.g., at 806a and 806b) may arrive at the UPF. When the UPF transmits an uplink packet on the N6 interface or receives an uplink packet on the N3/N9 interface, the UPF may measure the time difference between when two PDUs are transmitted or received. The UPF may measure the time difference when two packets belong to flows associated with the same XRM session identifier and the same correlation identifier. When the measurement result is greater than the synchronization threshold received from the SMF, the UPF may apply a delay to one or more flows to change the results of a subsequent measurement (e.g., to synchronize the flows).

As described with respect to FIG. 8, at 810, downlink packets may arrive at the UPF. When the UPF transmits a downlink packet on the N3/N9 interface (e.g., to either the first WTRU or the second WTRU) or receives a downlink packet on the N6 interface (e.g., from the DN), the UPF may measure the time difference between when two PDUs are transmitted or received. The UPF may measure the time difference when two packets belong to flows associated with the same XRM session identifier and the same synchronization group identifier. When the measurement result is greater than the synchronization threshold received from the SMF, the UPF may apply a delay to one or more flows to change the results of a subsequent measurement (e.g., to synchronize the flows).

As described with respect to FIG. 8, the uplink traffic procedures, the measurement synchronization and introduce delay procedure, and the downlink traffic procedures described herein (e.g., at 806a, 806b, 808, and/or 810) may be continuous and may take place simultaneously. They may represent the WTRU sending multiple PDUs to the UPF.

As described with respect to FIG. 8, the flows of the XRM session may use a common UPF that measures whether, and the extent to which, the flows are synchronized, and takes action to synchronize the flows. In examples, where different UPFs serve the flows of the XR session, the UPF may send packet arrival information to a network function. The network function may be called a coordination function (CoF). The packet arrival information may include a PDU transmission time, a PDU reception time, an XR session ID, and/or a synchronization group identifier. The CoF may use the packet arrival information from multiple UPFs to determine how flows are synchronized. If the CoF determines that one or more flows are not meeting a synchronization threshold, the CoF may request that one or more UPF(s) delay certain flow(s) by an amount the CoF determines.

Feature(s) associated with synchronizing at the WTRU based on PDU headers are provided herein. When the WTRU receives downlink PDUs, the WTRU may detect which PDU sets of a PDU session to synchronize (e.g., need to be synchronized).

The WTRU may use information (e.g., that the UPF added to the headers of the PDUs of the PDU set) to detect which flows to synchronize (e.g., need to be synchronized). For example, the WTRU may determine that PDU sets associated with the same synchronization group identifier are to be synchronized (e.g., need to be synchronized). In examples, the PDU set association and treatment rules (e.g., synchronization information) that were described herein may indicate to the WTRU which PDU set flows to synchronize (e.g., need to be synchronized). The PDU set flows may be identified with a PDU set identifier.

The WTRU may measure the level of synchronization between PDU set flows and compare it against a synchronization threshold provided to the WTRU in the PDU set association and treatment rules (e.g., synchronization information). If the WTRU detects that downlink PDU set flows are not within the synchronization threshold (e.g., are asynchronous), the access stratum part of the WTRU may apply a delay to one or more PDU sets before sending the information to the higher layers. In examples, the NAS layer of the WTRU may apply a delay to one or more PDU sets before sending the information to the higher layers. This delay may improve the perceived synchronization of the flows at the application layer.

In examples, the PDU set association and treatment rules (e.g., synchronization information) may indicate to the WTRU that certain PDU set flows may be delayed (e.g., always be delayed) before the associated information is sent to the application layer. The SMF may use measurement information from the UPF to determine how much delay to instruct the WTRU to apply.

Measuring the level of synchronization between PDU set flows may involve measuring the time difference between when a PDU set of a first PDU set flow is available to be presented to the application layer and when a PDU set of a second PDU set flow is available to be presented to the application layer.

Synchronizing at the UPF based on PDU headers may be provided. When the UPF receives uplink PDUs, the UPF may detect which PDU sets to synchronize (e.g., need to be synchronized).

The UPF may use information (e.g., that the WTRU added to the headers of the PDUs of the PDU set) to detect which flows to synchronize (e.g., need to be synchronized). For example, the UPF may determine that PDU sets associated with the same synchronization group identifier are to be synchronized (e.g., need to be synchronized). In examples, the PDRs that were configured in the UPF may indicate which PDU set flows to synchronize (e.g., need to be synchronized). The PDU set flows may be identified with a PDU set identifier.

The UPF may measure the level of synchronization between PDU set flows and compare it against a synchronization threshold provided to the UPF in the PDRs. If the UPF detects that uplink or downlink PDU set flows are not within the synchronization threshold, the UPF may delay one or more PDU sets before sending the information to the WTRU. This delay may improve the perceived synchronization of the flows at the application layer.

In examples, an N4 message from the SMF may indicate to the UPF that PDU set flows (e.g., certain PDU set flows) may be delayed (e.g., always be delayed) before the associated information is sent to the data network. The SMF may use measurement information from the WTRU to determine how much delay to instruct the UPF to apply. The SMF may receive the measurement information (e.g., synchronization information) from the WTRU via a NAS-SM message.

Correcting jitter may be provided. Techniques described herein may be used to correct jitter in flows. For example, the synchronization status information in Table 1 and provided to the WTRU and/or UPF may be enhanced to include jitter parameters (e.g., requirements). A jitter parameter (e.g., requirement) may be associated with a flow. The flow may be identified with a PDU set flow identifier, an IP 5-tuple, or a QFI. The jitter parameter (e.g., requirement) may be expressed as a minimum amount of time between PDU sets within a flow.

When the WTRU delivers a PDU set to the application layer, the WTRU may delay delivering a second PDU set of the same flow to the application layer until the minimum amount of time has passed. After the UPF transmits in the downlink (e.g., or uplink) the last PDU of a first PDU set, the UPF may determine to delay transmission of the first PDU of a second PDU set until after the minimum amount of time has passed.

The jitter parameter (e.g., requirement) may include a maximum time between PDU sets within a flow. When a WTRU determines that a first PDU set is ready to be delivered to the application layer and the amount of time that has passed since the last PDU set was presented to the application layer is greater than the maximum time between PDU sets, the WTRU may present the first PDU set to the application layer and may choose to not delay a second PDU set before presenting it to the application layer (e.g., even if the second PDU set is ready to be presented to the application before the minimum amount of time since presenting the first PDU set has elapsed). By not delaying the second PDU set, the WTRU may avoid creating a situation where the packets in flows become delayed because of a packet (e.g., a single packet) that experienced a network delay. The jitter parameter (e.g., requirement) may include a maximum time between PDU sets within a flow. When a UPF determines that a first PDU of a PDU set is ready to be transmitted and the amount of time that has passed since the last PDU of another PDU set was transmitted is greater than the maximum time between PDU sets, the WTRU may transmit the first PDU of the PDU set and may choose to not delay a first PDU of a second PDU set before transmitting it (e.g., even if the first PDU of the second PDU set is ready to be transmitted before the minimum amount of time since presenting the first PDU set has elapsed). By not delaying the second PDU set, the UPF may avoid creating a situation where the packets in flows become delayed (e.g., consistently delayed) because of a packet (e.g., single packet) that experienced a network delay.

Synchronization and jitter corrections may be provided at both the application and network layers. Application protocols such as RTP and IDMS may be used to correct synchronization between flows and jitter in flows. In one or more deployments, application layer protocols and the network layer protocol correction approaches described herein may be used. For example, application protocols such as RTP and IDMS may be used to resolve large synchronization and jitter issues (e.g., while the network layer protocol correction described herein may be used to resolve small synchronization and jitter issues). Large and small may refer to the time measure (e.g., temporal length) of the synchronization or jitter issue.

A WTRU application may determine that the level of synchronization or jitter achieved with an application layer protocol is insufficient and may send an indication to the WTRU that the network-based procedures described herein may be enabled. The WTRU may send a NAS-SM message to the SMF to indicate that the features may be enabled.

A network application (e.g., an AS) may determine that the level of synchronization or jitter achieved with an application layer protocol is insufficient and may send an indication to the PCF, via the NEF, that the network-based procedures described herein may be enabled. The PCF may send data to the SMF that serves the associated PDU session to indicate that the features may be enabled.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU), the WTRU comprising:
a processor configured to:
receive synchronization information associated with a protocol data unit (PDU) session, wherein the synchronization information indicates a synchronization group identifier and a synchronization threshold;
receive a first PDU set of a first data flow, and a second PDU set of a second data flow;
detect the synchronization group identifier in a header of the first PDU set and in a header of the second PDU set;
based on the detected synchronization group identifier, determine a synchronization value indicative of synchronization between the first data flow and the second data flow;
determine that the first data flow and the second data flow are asynchronous based on the synchronization value satisfying the synchronization threshold; and
send, to a network node, a non-access stratum-session management (NAS-SM) message indicating that the first data flow and the second data flow are asynchronous, wherein the network node comprises a session management function (SMF).

22. The WTRU of claim 21, wherein the synchronization value is based, at least in part, on a duration of time between a first time value associated with the first data flow and a second time value associated with the second data flow.

23. The WTRU of claim 21, wherein the processor being configured to determine the synchronization value comprises the processor being configured to:
determine a first time value associated with a transmission of data of the first data flow, and a second time value associated with a transmission of data of the second data flow; and
determine the synchronization value based on a duration of time between the first time value and the second time value.

24. The WTRU of claim 23, wherein the NAS-SM message further indicates the duration of time between the first time value and the second time value, wherein the duration of time is used to synchronize the first data flow and the second data flow.

25. The WTRU of claim 21, wherein the processor being configured to determine the synchronization value comprises the processor being configured to:
determine a first time value associated with an arrival of data of the first data flow, and a second time value associated with an arrival of data of the second data flow; and
determine the synchronization value based on a duration of time between the first time value and the second time value.

26. The WTRU of claim 25, wherein the NAS-SM message further indicates the duration of time between the first time value and the second time value, wherein the duration of time is used to synchronize the first data flow and the second data flow.

27. The WTRU of claim 21, wherein the synchronization threshold is indicative of a tolerable temporal separation between an onset of a first stimulus associated with the first data flow and an onset of a second stimulus associated with the second data flow.

28. The WTRU of claim 21, wherein the NAS-SM message further indicates a suggested amount of time by which to delay the first data flow or the second data flow to increase the degree to which the first data flow and the second data flow are synchronized.

29. The WTRU of claim 21, wherein the NAS-SM message further indicates a request for the first data flow and the second data flow to be synchronized.

30. A method, performed by a wireless transmit/receive unit (WTRU), the method comprising:
receiving synchronization information associated with a protocol data unit (PDU) session, wherein the synchronization information indicates a synchronization group identifier and a synchronization threshold;
receiving a first PDU set of a first data flow, and a second PDU set of a second data flow;
detecting the synchronization group identifier in a header of the first PDU set and in a header of the second PDU set;
based on the detected synchronization group identifier, determining a synchronization value indicative of synchronization between the first data flow and the second data flow;
determining that the first data flow and the second data flow are asynchronous based on the synchronization value satisfying the synchronization threshold; and
sending, to a network node, a non-access stratum-session management (NAS-SM) message indicating that the first data flow and the second data flow are asynchronous, wherein the network node comprises a session management function (SMF).

31. The method of claim 30, wherein the synchronization value is based, at least in part, on a duration of time between a first time value associated with the first data flow and a second time value associated with the second data flow.

32. The method of claim 30, wherein determining the synchronization value comprises:
determining a first time value associated with a transmission of data of the first data flow, and a second time value associated with a transmission of data of the second data flow; and
determining the synchronization value based on a duration of time between the first time value and the second time value.

33. The method of claim 32, wherein the NAS-SM message further indicates the duration of time between the first time value and the second time value, wherein the duration of time is used to synchronize the first data flow and the second data flow.

34. The method of claim 30, wherein determining the synchronization value comprises:
determining a first time value associated with an arrival of data of the first data flow, and a second time value associated with an arrival of data of the second data flow; and
determining the synchronization value based on a duration of time between the first time value and the second time value.

35. The method of claim 34, wherein the NAS-SM message further indicates the duration of time between the first time value and the second time value, wherein the duration of time is used to synchronize the first data flow and the second data flow.

36. The method of claim 30, wherein the synchronization threshold is indicative of a tolerable temporal separation between an onset of a first stimulus associated with the first data flow and an onset of a second stimulus associated with the second data flow.

37. The method of claim 30, wherein the NAS-SM message further indicates a suggested amount of time by which to delay the first data flow or the second data flow to increase the degree to which the first data flow and the second data flow are synchronized.

38. The method of claim 30, wherein the NAS-SM message further indicates a request for the first data flow and the second data flow to be synchronized.
